(19) United States
(12) Patent Application Publication
(10) Pub. No.: US 2020/0211109 A1
(43) Pub. Date: Jul. 2, 2020

(54) METHODS AND SYSTEMS FOR MARGIN LENDING AND TRADING ON A DECENTRALIZED EXCHANGE

(71) Applicant: bZeroX, LLC, Dover, DE (US)

(72) Inventors: Thomas Bean, Dover, DE (US); Kyle Kistner, Dover, DE (US)

(21) Appl. No.: 16/237,652

(22) Filed: Dec. 31, 2018

(51) Int. Cl. G06Q 40/04; G06Q 40/02; G06Q 30/02; G06Q 20/06

(52) U.S. Cl. CPC G06Q 40/04; G06Q 20/0658; G06Q 30/0208; G06Q 40/02

(57) ABSTRACT

bZx is built on Ethereum and integrated with the 0x protocol. It is the first fully decentralized, peer-to-peer margin funding and trading protocol. bZx is not itself an exchange, but a protocol that can be integrated into the current exchange infrastructure. Exchanges and relays are incentivized by fees denominated in the BZRX protocol token (BZRX) to offer decentralized margin lending and margin trading services. Assets are valued and liquidated via competing oracle providers. By decoupling the valuation and liquidation of assets from the protocol, the oracle marketplace approach allows competition to drive the oracle provider fee to its marginal cost while encouraging experimentation and flexibility.

### FIELD OF DISCLOSURE

The present disclosure generally relates to the lending and trading of assets and currencies on a decentralized exchange, more specifically, the present disclosure relates

### BACKGROUND

Traders and lenders, two core components of the emerging decentralized asset ecosystem, currently must choose between decentralized exchanges with limited functionality and centralized exchanges with limited control. Both parties suffer from this trade-off between security and features: lenders forgo lucrative interest because they cannot provide funds for margin trading on decentralized exchanges, and traders using decentralized exchanges cannot access the power of leverage or shorting because their exchange does not facilitate margin trading. As the number of lenders, traders, and decentralized exchanges grow, the demand for a solution that can enhance decentralized exchanges with margin trading will continue to increase.

One of the persistent contradictions of the cryptocurrency space has been the theme of decentralized assets traded on centralized exchanges.

In the wake of the 0x revolution, a new generation of decentralized exchanges (DEXs) are taking root. These decentralized exchanges address some of the existing problems with older DEXs, while still lacking the capabilities of many of the leading centralized exchanges. Individuals looking to engage in margin lending or margin trading are still forced to funnel their liquidity to centralized token and coin exchanges, exposing them to an additional form of counterparty risk.

Counterparty risk is encountered when the risk of a third party defaulting jeopardizes the assets of an investor. Margin lending exposes the lender to counterparty risk both from the exchanges and the borrower. The specific type of avoidable counterparty risk incurred by lenders and borrowers using centralized exchanges is called custodial risk; allowing individuals to maintain control of the private keys to their wallets at all times obviates this risk. Lenders face additional counterparty risk from underwater borrowers who fail to be liquidated in time.

Decentralized margin comes with significant technical challenges. The most significant challenge is the design of a reliable oracle that can match the settlement security of centralized exchanges. In the context of margin lending, the oracle problem is caused because Ethereum contracts are not natively aware of asset prices on or off the blockchain. If smart contracts can't stay aware of asset prices on the open market, they can't consistently force-liquidate borrowers on that market to protect lenders from adverse movements. The most serious obstacle to decentralized margin lending is being able to reliably and securely liquidate troubled positions.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicant. In addition, the drawings may contain other marks owned by third parties and are being used for illustrative purposes only. All rights to various trademarks and copyrights represented herein, except those belonging to their respective owners, are vested in and the property of the Applicant. The Applicant retains and reserves all rights in its trademarks and copyrights included herein, and grants permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1 illustrates a block diagram of an operating environment consistent with the present disclosure;

FIG. 2 illustrates another block diagram of an operating environment consistent with the present disclosure;

FIG. 3 illustrates a block diagram of an example of a bounty hunter liquidation process consistent with the present disclosure;

FIG. 4 illustrates a block diagram of an example of a lender payout consistent with the present disclosure;

FIG. 5 illustrates one embodiment of an interface for generating an order object;

FIG. 6 illustrates one embodiment of an interface for designating funds in an order object;

FIG. 7 illustrates one embodiment of an interface for specifying an oracle and other parameters of an order object;

FIG. 8 illustrates one embodiment of an interface for specifying additional parameters of an order object;

FIG. 9 illustrates one embodiment of parameters of an order object; and

FIG. 10 is a flow chart of a method for operating various embodiments of the present disclosure.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 35 U.S.C. § 112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in, the context of bZeroX and its trade name protocols, embodiments of the present disclosure are not limited to use only in this context. Any reference to a bZeroX protocol should be considered a reference to a generic protocol capable of perform the same or similar functions. Moreover, the methods and systems herein may be collectively referred to as a “platform.” Any reference to a platform may be a reference to any one module or any one stage of the methods and systems disclosed herein.

### I. Platform Overview

Embodiments of the present disclosure may provide a decentralized protocol that enables lending and borrowing for margin trading. The protocol can be easily integrated into new and existing exchanges or accessed simply through the native portal. The protocol benefits lenders, traders, and decentralized exchanges. Lenders will be able to loan their tokens for lucrative interest without risking moving their assets onto centralized exchanges that can be compromised. Likewise, traders are able to margin trade without moving their assets onto centralized exchanges that can be compromised. Finally, decentralized exchanges benefit from increased volume, better feature provision, and trading fees.

Sample Use Case:

Angie, an ETH holder, wants to capitalize on her holdings by lending them to a margin trader, but she does not want to move her ether onto a centralized exchange that could be hacked. Using the bZx portal or an integrated relay, she issues a peer to peer loan straight from her wallet. She can feel safe in the knowledge that her ETH is secured by smart contracts, never having to worry about losing money on a loan.

Sample Use Case:

Delsos, a Trader, wants to open a long position with additional leverage on an ERC20 token. Delsos looks for the exchange with the lowest interest rate, minimizing the cost of utilizing leverage. Eventually, Delsos settles on a decentralized exchange integrated with the bZx protocol; interest rates are almost always lower for non-custodial margin loans because lenders don't have to be compensated for the risk of the exchange being hacked.

Sample Use Case:

A decentralized exchange wants to increase trading volume and liquidity. They integrate the bZx protocol into the DEX, allowing market makers to hedge risk while providing order book liquidity.

Embodiments of the present disclosure may comprise methods, systems, and a computer readable medium comprising, but not limited to, at least one of the following:

I. A UI Layer;

II. A Relay Layer;

III. An API Layer;

IV. A Protocol Layer;

V. An Oracle Layer; and

VI. A Decentralized Exchange Layer.

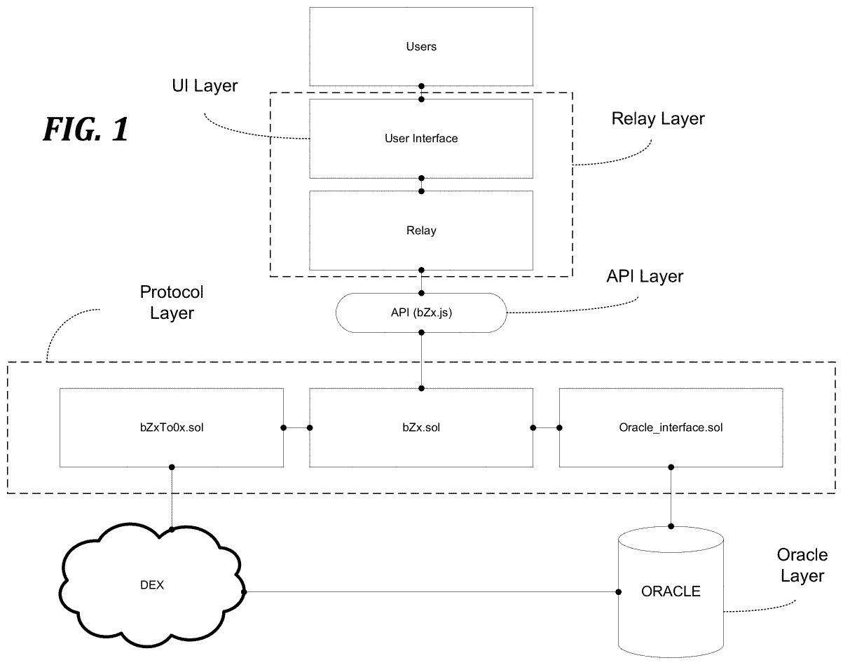

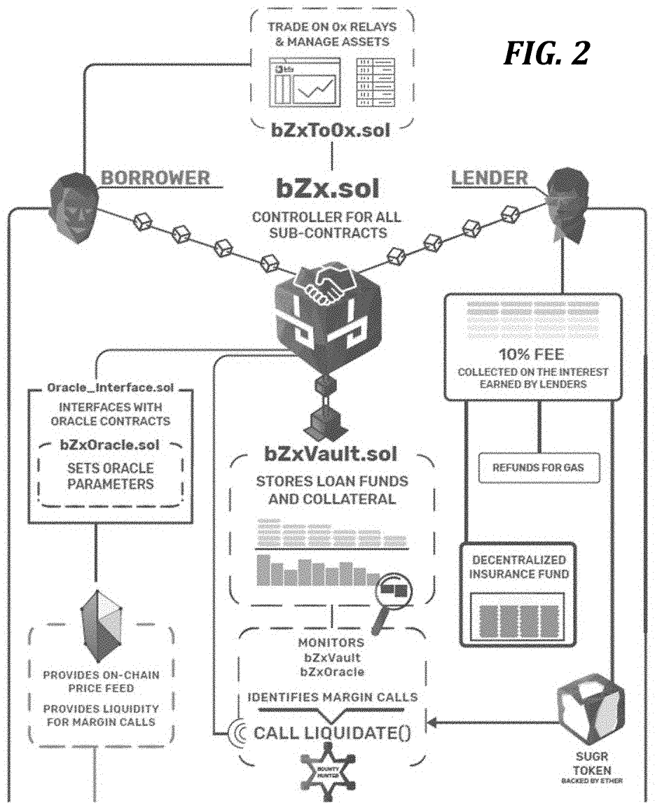

FIG. 1 illustrates a block diagram of an operating environment consistent with the present disclosure. FIG. 2 illustrates another block diagram of an operating environment consistent with the present disclosure. Details with regards to each module is provided below. Although modules are disclosed with specific functionality, it should be understood that functionality may be shared between modules, with some functions split between modules, while other functions duplicated by the modules. Furthermore, the name of the module should not be construed as limiting upon the functionality of the module. Moreover, each stage disclosed within each module can be considered independently without the context of the other stages within the same module or different modules. Each stage may contain language defined in other portions of this specifications. Each stage disclosed for one module may be mixed with the operational stages of another module. In the present disclosure, each stage can be claimed on its own and/or interchangeably with other stages of other modules.

Embodiments of the present disclosure may provide a system comprising:
a user interface (UI) layer,
   wherein the ui layer provides an interface for at least one of the following:
      a maker, wherein the maker is enabled open an order with a creation of an order object,
      a taker, wherein the taker is enabled to accept the order and complete the order object, and
      a bounty hunter, wherein the bounty hunter is enabled to view the order object and trigger a liquidation of the order associated with the order object,
a relay layer,
   wherein the relay layer is configured to perform at least one of the following:
      broadcast the order object,
      receive an acceptance and completion of the order object, and
      relay the order object to a protocol layer, and
a protocol layer,
   wherein the protocol layer comprises at least one of the following:
      an entry smart contract for receiving the accepted and completed order object,
      an escrow smart contract for holding funds associated with the order object,
      an oracle interface smart contract for interfacing with at least one oracle smart contract.

Embodiments of the present disclosure may provide the aforementioned system, wherein the order object represents a margin loan.

Embodiments of the present disclosure may provide the aforementioned system, wherein the protocol layer is configured to perform at least one of the following:
monitor activity associated with the margin loan,
request validation, from the oracle smart contract, for the activity associated with the margin loan,
receive validation, from the oracle smart contract, for the activity associated with the margin loan, and
permit, upon receipt of validation, the activity by at least one of the following:
   a trader,
   a lender, and
   the bounty hunter.

Embodiments of the present disclosure may provide the aforementioned system, wherein the order object specifies the oracle smart contract to be used for governing the margin loan.

Embodiments of the present disclosure may provide the aforementioned system, further comprising an oracle market place for selecting the oracle smart contract.

Embodiments of the present disclosure may provide the aforementioned system, wherein the maker and the taker mutually agree upon the oracle smart contract.

Embodiments of the present disclosure may provide the aforementioned system, wherein the protocol layer is configured to perform, based at least in part on parameters of the order object, at least one of the following:
escrow funds associated with the margin loan,
track all trades associated with the margin loan,
close all positions associated with the margin loan, and
distribute the funds associated with the margin loan.

Embodiments of the present disclosure may provide the aforementioned system, wherein the distribution of funds by the protocol layer is comprises at least one incentive for at least one of the following:
the lender,
the trader,
the bounty hunter,
the relay, and
the oracle smart contract.

Embodiments of the present disclosure may provide the aforementioned system, further comprising an API layer, wherein the API layer is configured to enable a communication between the relay layer and the protocol layer.

Embodiments of the present disclosure may provide the aforementioned system, wherein the UI layer and the Relay Layer are off-chain, and wherein the protocol layer and the oracle layer are, at least in part, on-chain.

The following depicts an example of a method of a plurality of methods that may be performed by at least one of the aforementioned modules. Various hardware components may be used at the various stages of operations disclosed with reference to each module. For example, although methods may be described to be performed by a single computing device, it should be understood that, in some embodiments, different operations may be performed by different networked elements in operative communication with the computing device. For example, server \hat{ }10 and/or computing device *00 may be employed in the performance of some or all of the stages disclosed with regard to the methods. Similarly, apparatus \hat{ }05 may be employed in the performance of some or all of the stages of the methods. As such, apparatus \hat{ }05 may comprise at least those architectural components as found in computing device *00.

Furthermore, although the stages of the following example method are disclosed in a particular order, it should be understood that the order is disclosed for illustrative purposes only. Stages may be combined, separated, reordered, and various intermediary stages may exist. Accordingly, it should be understood that the various stages, in various embodiments, may be performed in arrangements that differ from the ones claimed below. Moreover, various stages may be added or removed from the without altering or deterring from the fundamental scope of the depicted methods and systems disclosed herein.

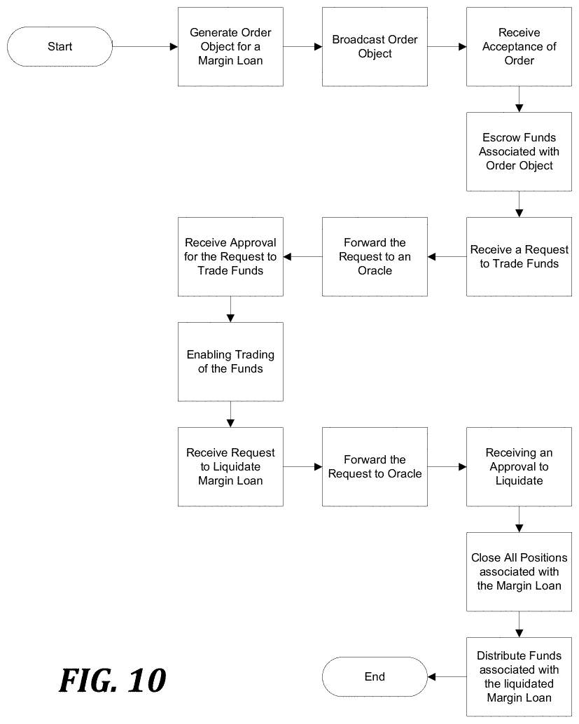

Consistent with embodiments of the present disclosure, a method may be performed by at least one of the aforementioned modules. FIG. 10 illustrates an embodiment of the method. The method may be embodied as, for example, but not limited to, computer instructions, which when executed, perform the method. Embodiments of the present disclosure may provide a method comprising:
generating an order object for a margin loan,
   wherein the order object comprises a plurality of parameters for specifying aspects of the margin loan and an oracle smart contract for governing the margin loan;
broadcasting the order object for the margin loan,
   wherein broadcasting the order object comprises displaying at least one of the plurality of parameters for specifying the margin loan;
receiving an acceptance of the margin loan represented by the order object,
   wherein receiving the acceptance of the margin loan comprises completing at least one additional parameter of the order object;
escrowing funds associated with the margin loan,
   wherein the funds are escrowed by an escrow smart contract;
receiving a request for trading the funds on a decentralized exchange,
   wherein the request is forwarded to the oracle smart contract for governing the margin loan;
approving the trade of funds,
   wherein the approval is received from the oracle smart contract; and
enabling the trading the funds on the decentralized exchange,
   wherein the trading of funds on the decentralized exchange is enabled by at least one of the following: an exchange interfacing smart contract and an oracle interfacing smart contract.

Embodiments of the present disclosure may provide the aforementioned method, further comprising:
receiving a request to liquidate the margin loan;
forwarding the request to the oracle smart contract; and
receiving an approval to liquidate the margin loan from the oracle smart contract.

Embodiments of the present disclosure may provide the aforementioned method, further comprising liquidating the margin loan, wherein liquidating the margin loan comprises:
closing all positions associated with the margin loan, and
distributing the funds associated with the margin loan.

Embodiments of the present disclosure may provide the aforementioned method, wherein distributing funds comprises providing at least one incentive for at least one of the following:
the lender,
the trader,
the bounty hunter,
the relay, and
the oracle smart contract.

Embodiments of the present disclosure may provide the aforementioned method, wherein receiving the request to liquidate the margin loan comprises receiving a request invoked by a bounty hunter.

Embodiments of the present disclosure may provide the aforementioned method, further comprising:
retrieving at least one price associated with assets associated with the margin loan.

Embodiments of the present disclosure may provide the aforementioned method, wherein retrieving the at least one price comprises:
retrieving the prices from a plurality of decentralized exchanges,
removing outliers values from the retrieved prices,
taking the volume waited average (VMA) of the retrieved prices without the outliers, and
compare the VMA with at least one parameter in the order object.

Embodiments of the present disclosure may provide the aforementioned method, further comprising granting approval for the liquidation of the margin loan.

Embodiments of the present disclosure may provide the aforementioned method, wherein granting the approval for the liquidation of the margin loan comprises granting the approval based on the comparison of the VMA to the at least one parameter of the order object.

Embodiments of the present disclosure may provide the aforementioned method, further comprising calculating a reward for the bounty hunter,
wherein the reward is based, at least in part, on a fee paid by the bounty hunter to invoke the liquidation of the margin loan.

Both the foregoing overview and the following detailed description provide examples and are explanatory only. Accordingly, the foregoing overview and the following detailed description should not be considered to be restrictive. Further, features or variations may be provided in addition to those set forth herein. For example, embodiments may be directed to various feature combinations and sub-combinations described in the detailed description.

### II. Platform Configuration

FIG. \hat{ } illustrates one possible operating environment through which a platform consistent with embodiments of the present disclosure may be provided. By way of non-limiting example, a platform \hat{ }00 for providing the methods and systems for may be hosted in both a blockchain protocol (“on-chain”) and off of a blockchain protocol (“off-chain”). One possible embodiment of the platform may be provided by the BZRX™ protocol provided by bZeroX, LLC. It should be understood that layers and stages performed by the layers may be either “on-chain” or “off-chain.” The present disclosure anticipates embodiments with variations as to which stages may be performed “on-chain” or “off-chain.”

Accordingly, as illustrated in FIG. \hat{ }, embodiments of the present disclosure provide a software and hardware platform comprised of a distributed set of modules, including, but not limited to:
a. A UI Layer;
b. A Relay Layer;
c. An API Layer; and
d. A Protocol Layer.

In some embodiments, the present disclosure may provide an additional set of modules for further facilitating the software and hardware platform. The additional set of modules may comprise, but not be limited to:
a. An Oracle Layer; and
b. A Decentralized Exchange Layer.

The aforementioned modules and functions and operations associated therewith may be operated by a computing device. In some embodiments, each module may be performed by separate, networked computing devices; while in other embodiments, certain modules may be performed by the same computing device. Accordingly, embodiments of the present disclosure provide a software and hardware platform comprising a distributed set of computing elements, including, but not limited to:

1. User Interface Layer

Consistent with embodiments of the present disclosure, a user interface (UI) can be in any form, including but not limited to API (such as REST), text-based terminal, web app, website, executable, mobile app, SSH tunnel, macro embedded in an application such a Microsoft Office, or even an interface on a Decentralized Exchange (DEX). User Interfaces can be implemented by/for Relays and DEXs. Furthermore, a UI need not be provided by the platform. Rather, a UI can simply be a character-based terminal for interfacing with the platform.

2. Order Object

Consistent with embodiments of the present disclosure, the parameters for a margin loan may be embodied within an order object (OO). The OO may describes certain loan parameters to be agreed upon.

3. Relays

Consistent with embodiments of the present disclosure, relays may help connect users to the platform of the present disclosure (e.g., bZx protocol). In some embodiments, relay may provide a market place for margin loans. The relay may provide many functions to the lender, borrower, or bounty hunter. The relay may also act as a marketplace or an order book for loans. For example, a relay may generate orders, take orders, and relay off-chain orders to the on-chain smart contracts of the platform (e.g., bZx protocol). By way of non-limiting example, the relay may provide the following functions:
Provide a UI for the lenders and traders to make and take bZx orders;
Broadcasts open orders over a medium of choice (any possible communication medium chosen by the Relay);
Provide a UI for the trader to manage the loan once the funds are lent, including the opening of trades, the closing of trades, and ending a loan early;
Provide a UI for the lender to manage the loan once the funds are lent, including reviewing how their funds are being used and requesting an interest payout; and
Provide a UI for the bounty hunters to manage open trades for margin liquidation, and to liquidate if needed.

One example of a relay may be the bZx portal. The bZx Portal is a web-based decentralized application that serves as a frontend to the bZx protocol, utilizes the bZx.js library, and serves as a one-stop shop for individuals looking to interact with the protocol for margin lending and trading. There is no requirement to use the bZx Portal for lending or trading on bZx, but it provides a convenient access point for users that aren't otherwise on an exchange or relay.

4. API

Consistent with embodiments of the present disclosure. the user interface and relay layer may interface with the platform through an API. The API may comprise, for example, the bZx.js library. The API may provide a promise-based, asynchronous JavaScript library that contains ALL functions needed to interact with the protocol layer. Can be used as an API, or just as an example of how to interact with the protocol.

As one example, relays and exchanges will use this library to build an interface for margin lending and trading on bZx, providing a value-add to their customers. These relays will be able to add a funding tab, similar to many centralized exchanges. In the same way that 0x.js allowed relays to easily create a frontend for exchanges, bZx.js will do likewise for funding.

5. Protocol Layer

a. BZRX Token

Consistent with embodiments of the present disclosure, the protocol layer may be a decentralized system operative on a blockchain in conjunction with the use of a protocol token. One such example is the BZRX token, although different implementations may provide for different tokens to serve a similar purpose. The protocol token may be a utility token is a combination of Medium of Exchange and Governance with two main functions:
1) The incentivization of order book aggregation by relays; and
2) Governance of the protocol.

As such, the BZRX token functions for the bZx protocol much like the ZRX token functions for the 0x protocol. Both tokens coordinate networks of rational economic agents around a protocol. Both are used to facilitate continuous, decentralized updates to the protocol. In various embodiments, margin trading fees to relays are paid using this token.

b. bZx.sol

Consistent with embodiments of the present disclosure, the protocol layer may comprise a smart contract that serves as the entry point for all state changing transactions on the protocol. One such example is the bZx.sol smart contract for the bZx protocol. The smart contract may server as the controller of other sub-contracts that make up the various parts of the protocol, including, for example, but not be limited to, the bZxVault.sol, bZxTo0x.sol, and the custom Oracle contracts for trade management.

c. bZxVault.sol

Consistent with embodiments of the present disclosure, the protocol may employ an escrow account for holding funds. As one example, bZxVault.sol may server as an escrow contract for storing ether and tokens not involved in active trades.

d. bZxTox.sol

Consistent with embodiments of the present disclosure, the protocol may employ a means for interfacing with a decentralized exchange on which trading activity may be performed (under the regulation of the protocol and oracle layers). As one example, bZxTo0x.sol may provide an interface for taking trades using the 0x Exchange contract. The contract can be upgraded later if ZeroEx makes breaking changes to their on-chain exchange.

e. Oracle_Interface.sol

Consistent with embodiments of the present disclosure, the protocol may employ a means for interfacing with an oracle for regulating trading activity on the protocol. As one example, Oracle_Interface.sol may provide interface provided as a starting point for developing custom Oracle contracts that interact with the bZx protocol and make up the oracle marketplace. Though funds are escrowed in the bZxVault, trades are escrowed by the oracle, meaning the oracle and not the bZx protocol has sole discretion to withdraw or liquidate the funds within the constraints of the protocol logic.

As on example, the bZx protocol is a series of smart contracts that facilitate on-chain margin lending, and the opening, monitoring, and liquidation of ERC20 token trades. The entry point for all state changing transactions with bZx is the bZx.sol smart contract. This acts as a controller of other sub-contracts that make up the various parts of the protocol, including bZxVault.sol, bZxTo0x.sol, and the custom Oracle contracts for trade management.

The interaction with the bZx smart contracts begins when a lending order is sent to bZx.sol. Whether a person wishes to lend funds or borrow funds, this lending order is generated when that person defines the loan parameters on a 3rd party relay (integrated with bZx.js) or on the bZx Portal directly. This order is broadcast through any medium, though most likely through a relay. Takers bring signed orders to the bZx contract, initiating the margin lending process. A series of competing oracle contracts form the basis of an oracle marketplace and can be selected by users based on their preference, as part of the order creation process. The oracle contract chosen is responsible for overseeing positions taken using that oracle, managing the price feed, and controlling liquidation logic. Any desired oracle can be chosen by the user when the order is created, as long as the oracle has been registered in the bZx Oracle Registry contract. Oracle contracts that make it into this registry will have their source code published and will have been publicly vetted and accepted through decentralized governance, ensuring they are safe and reliable. bZx intends to maintain a marketplace of these oracles, allowing for public rating, and providing a means to select an oracle that meets the public's qualifications.

6. Oracle Layer

Blockchain oracles, by definition, onboard information that exists outside the blockchain onto the blockchain so that smart contracts can be useful in the real world. Blockchain oracles see what the native blockchain cannot. For example, Ethereum smart contracts are not natively aware of asset prices on and off the blockchain. This limits the ability of a decentralized exchange contract to provide margin lending and trading on the Ethereum platform, as it is not natively able to keep track of asset prices.

Oracles introduce a significant complication to the decentralized margin lending problem. Even if an oracle is decentralized and interfaces with on-chain price information, network congestion can pose a significant threat to its ability to liquidate a position in a timely manner. As on example, the approach bZx has chosen is to create an oracle marketplace where oracle providers compete, allowing providers and users to select the trade-offs tailored to the individual. This system will allow oracle services to be provided at the lowest possible fees with the highest reliability. Any individual or organization will be able to create their own oracle. If the oracle is successful, the creators will either profit from token schemes facilitating seigniorage or from fees on interest earned by the lender. An oracle provider can charge any fee they want, but individuals may choose not to use them if the fee is too high.

As on example, the bZxOracle may be a fully decentralized smart contract system and operate partially off-chain. When creating an order, an oracle provider must be specified. If the bZxOracle is specified, then anyone can call the liquidateTrade contract method and receive a bounty when the proper conditions are met. Support is provided at the protocol level to allow third-party oracles to impose whatever constraints necessary on when the liquidateTrade method can be called. With bZxOracle, bounty hunters keep track of all open trades taken using bZx, determining whether any have gone below margin maintenance. This pushes the most computationally intensive tasks off-chain. When a bounty hunter has determined that a position has gone below margin maintenance, they call into bZx to liquidate the trade with bZxOracle.

After the liquidateTrade method has been called, the bZx contract makes a call to the bZxOracle contract (FIG. 1) to determine whether the position has gone under margin maintenance. The bZxOracle contract pulls from the most liquid three decentralized exchange APIs. The average disagreement between each price provided by the API is calculated. The DEX which provided the number with the highest average disagreement is discarded and the two remaining DEXs are used in the calculation of the volume weighted average price. This is done to prevent temporary, erroneous prices from allowing a borrower to be wrongly liquidated. This also provides protection against bounty hunters seeking to maliciously liquidate orders to extract a greater sum of bounties. While more sophisticated outlier detection algorithms might seem preferable, the platform may opt for this method to limit gas costs. The platform may initially only be using the on-chain price feed from KyberNetwork until other secure on-chain price feeds come online.

When the liquidateTrade method is called for a trader's open position, and the trade is confirmed to require liquidation, an on-chain trade is made to close the position. During times of high congestion, it becomes increasingly likely that any single transaction sent will be knocked out of the mempool and fail to be mined. Traders are familiar with this phenomenon during popular ICOs, where network congestion has prevented many individuals from successfully participating in a token sale.

One of the principal design considerations for bZxOracle was to have it work in even extraordinary circumstances. Once an account is identified as being below margin maintenance, it is imperative that it is liquidated as quickly as possible with the fewest number of transactions required to be mined. This is why the platform may be configured to crowdsource liquidation calls. This is also why the platform may design the system to work without user intervention even during times of market crisis.

In bZxOracle, a ten percent fee will be collected from the interest earned by lenders and will be used for several functions, including: decentralized governance, bounty hunter incentivization, gas fee refunds, and systemic risk insurance. By contrast, many centralized exchanges charge fifteen percent or more of the interest earned. Since bZxOracle will be competing in an oracle marketplace, market forces will eventually force the oracle fee down to the marginal cost of providing the service. The platform may incentivize individuals to fork the open-source code and compete with their own variant of our oracle if they believe they can deliver better results. For example, in times of low network congestion, a lender might feel comfortable using a fee-free fork of the code and being their own bounty hunter. While this forgoes the protection of a network of individuals crowd-sourcing transactions, this trade-off might be preferable for some lenders and borrowers.

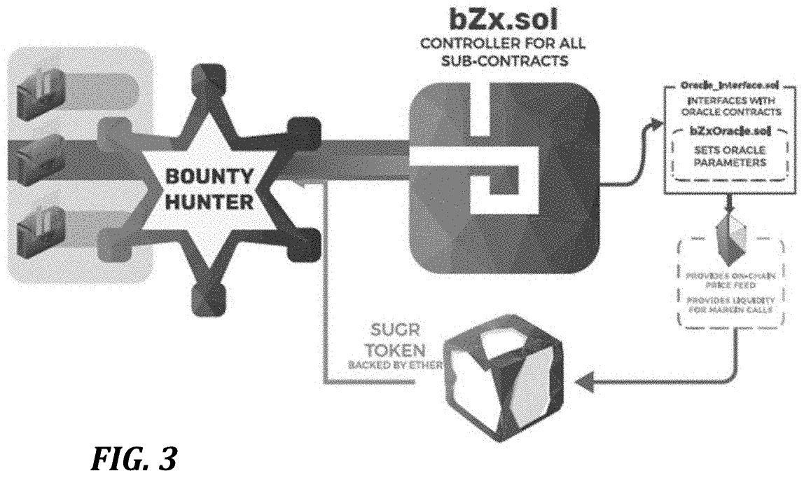

Bounty hunters will be paid a bounty to compensate them for the gas spent calling the contract and the resources spent monitoring margin account health off-chain. FIG. 3 illustrates a block diagram of a bounty hunter operation. In order to establish the average price of gas on the network, the platform may extract the gas price data from the takers bringing signed orders to the bZx contract. The platform may use this data to update an exponential moving average (EMA) which represents the price of gas on the network. The higher the gas price used in prior transactions, the higher the bounty will be. This will enable the bounty to dynamically scale in sync with network congestion, ensuring that liquidation transactions always maintain priority in the transaction queue. If this bounty proves insufficient or excessive, it can be modified by the oracle's decentralized governance mechanism discussed below.

Embodiments of the present disclosure may provide two trade-offs when setting the bounty size. The first is that if the bounty is set too high, a race condition will cause bounty hunters to use a gas price far above what is necessary to be at the front of the transaction queue, burning gas to compete with other bounty hunters. This would create great deadweight loss, compensating miners far more than is necessary to process the transaction quickly. The second trade-off is that if the bounty is set too low, the average gas price used to process the transaction won't be enough to make it past the transaction queue, causing liquidations to take too long or not be mined at all. After determining an upper bound on gas used by calls to the liquidateTrade method, the bounty will be set such that bounty hunters are incentivized to send transactions with a gas price slightly above the average.

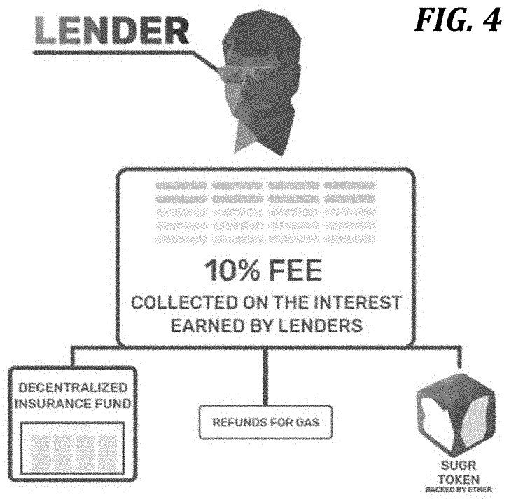

The fees collected by bZxOracle will be tokenized and distributed to its users. FIG. 4 illustrates just on example of a distribution. Lenders and borrowers will receive Sugar (SUGR) tokens to compensate them for taker fees and gas. Bounty hunters will receive Sugar tokens as their bounty. This token will be used to decentralize governance of the oracle, giving the individuals invested in the network a vote in proportion to their usage. SUGR tokens are backed by Ether and redeemable for a fixed percent of the bZxOracle reserve. As bZxOracle collects more fees, the Ether reserve grows along with the value of the SUGR token. The distribution of the SUGR token will take strong inspiration from Ethfinex and their Nectar token. The SUGR token roll-out will be incremental, with the oracle initially distributing Ether to the lenders, borrowers, and bounty hunters.

The volatility of cryptocurrencies create a high risk that a cascade of margin calls could cause a flash crash. Part of the fees collected by bZxOracle will be set aside into a decentralized insurance fund denominated in Ether and BZRX token to protect lenders in the event of a black swan event. If many lenders have lost principal due to abnormal market circumstances, the holders of the Sugar token are incentivized to use the insurance fund to restore the principal of the lenders. This maintains the reputation of the network as a safe place to loan funds and safeguards the future revenue of the Sugar token. Part of the task of governance of the oracle is to decide what loan order parameters are insurable. It might be decided that providing loans for margin traders using leverage over a certain threshold are ineligible for the oracle's insurance.

Accordingly, embodiments of the present disclosure may provide an oracle layer that provide certain key features, including, but not limited to:
a. Creation/Registration
   Can be created by anyone at anytime
   Must be registered in the bZx Oracle Registry
   Must have source code published
   Must be publicly vetted and accepted through decentralized governance
b. Marketplace
   Basis formed by competing Oracles
   Contains all registered and publicly accepted Oracles
   Contains public rating for each Oracle
   Lender/Trader can pick Oracle commissioned by self
c. Responsibilities
   Oversee positions taken
      Keep track of trades
      Accept/Reject trades
   Manage price feed
   Control liquidation logic
   Monitoring of the margin accounts;
   Pricing the margin accounts; and
   Sourcing liquidity for margin calls.
d. Governance
   Fees chosen by Oracle contract
      0 fee is allowed
      Oracle fee chosen
      BH fee chosen
      Taker fee chosen
   Reliability depends on Oracle contract logic
   Can be partially centralized
   Can be fully or partially on-chain
   Can impose constraints on liquidation method
   Can choose the payout token used for
      Gas reimbursements
      BH payouts
      Taker fees
   Can choose source(s) of price feed
   Can choose prices to consider for liquidation logic
   Can limit who can become a bounty hunter (BH)
      Trader/Lender can be own BH
   Can control and make all trades
   Can control Gas price calculation logic
   Can control Insurance Fund (DIF)
      No funds allocated for DIF allowed
      Amount of funds allocated for DIF
      Source of funds for DIF
   Can decide what loan parameters are insurable

For example, in one embodiment, a price feed method (PFM) may be provided. Price Feed Method (PFM) may comprise, for example, but not be limited to, the following stages:
Price feed request is initiated by the user on the Relay using the UI
bZx.sol receives the price feed request from the Relay via API
bZx.sol sends request to Oracle via Oracle_Interface.sol
Price feed is received by bZx.sol from the Oracle
bZx.sol forwards the price feed to the Relay
Price feed is presented to the user using the UI by the Relay

Blockchain orcales see what the native blockchain cannot. Ethereum smart contracts are not natively aware of asset prices on and off the blockchain. This limits the ability of a decentralized exchange contract to provide margin lending and trading on the Ethereum platform, as it is not natively able to keep track of asset prices. Without a source of pricing information, borrowers cannot be force-liquidated in the event of a margin call, leaving lenders open to adverse market movements. A reliable oracle is needed to import the asset price data necessary for margin trading to occur on Ethereum.

The open-source bZx protocol allows for any type of oracle-based solution to be built with regards to margin lending. For example, the flagship oracle, bZxOracle, uses KyberNetwork's on-chain feeds to provide consistent and accurate market data. Off-chain bounty hunters, users that monitor the solvency of margin accounts, let the contracts know when it is time to consult with the price data to determine whether a margin call is necessary. In the rare event of a flash crash, a guarantee fund pays out losses to lenders. As lenders provide the resources necessary for margin trading, their protection is of the utmost importance. Another oracle solution can be seen with bZx's strategic partnership with Chainlink, the leader in trusted oracle services. Price feeds and liquidity powered by a Chainlink-based oracle opens up a wider range of margin calling options for lenders and traders in addition to allowing all ERC20s and ERC721s to be supported by the protocol.

Centralization falls along a spectrum, from completely centralized by a single party, to partially decentralized among a consortium of trusted parties, to completely decentralized among a network of unaffiliated individuals. Furthermore, there are several key features of a margin call that can fall along this spectrum of centralization. These features include:

(1) who monitors the margin accounts

(2) who prices the margin accounts

(3) where liquidity for margin calls is sourced.

Within a single system it is possible to mix and match solutions exhibiting varying degrees of centralization for each of these essential features. For example, lenders or relays could monitor their own margin accounts, making the monitoring of margin accounts centralized and vulnerable to a single point of failure. A more decentralized option would be for a consortium of relays or an M-of-N multisignature wallet to monitor margin accounts. At the extreme end of the decentralization spectrum would be a permissionless system where anyone can monitor margin accounts.

The pricing of margin accounts follows a similar pattern. The pricing of margin accounts comes into play when it is time to execute a margin call against a margin account that is under margin maintenance. A completely centralized approach might allow a lender or relay to unilaterally liquidate a margin trader based on their own interpretation of the health of the margin account. This has the downside of giving the margin trader no assurances that their loan will not be called in prematurely. The risk is particularly high when it is the lender tasked with valuing the margin account. Further along the decentralization continuum are the use of a price feed in conjunction with another party that executes the margin call. At the extreme end of decentralization you have the averaged price of multiple price feeds working in coordination with individuals performing their own calculations and executing a margin call when a position is in need of liquidation. Such a decentralized system gives traders confidence that their margin loan will not be called in prematurely.

Lastly, there is the question of where liquidity comes from once a margin call has been successfully initiated. An example of complete centralization would be a lender or relay providing liquidity from their own stockpiles or orderbooks. This presents a danger because a malicious liquidity provider could intentionally misprice assets to the benefit of a lender or trader. There are several decentralized approaches to providing liquidity which include the use of on-chain DEXs, Chainlink oracles, or permissionless Dutch Auctions. The Dutch Auction approach has the strength of allowing liquidity to be sourced from the entire ecosystem, lowering liquidity risk. The downside of this approach is that Dutch Auctions take a significant amount of time and expose lenders to the volatility of the market, essentially trading liquidity risk for counterparty risk. In contrast, on-chain DEXs and Chainlink oracles exhibit a higher liquidity risk while shielding lenders from counterparty risk. This protection from counterparty risk is a result of their ability to execute margin calls instantly.

In summary, bZx is the first protocol to allow secure margin lending on decentralized exchanges. Lenders no longer need to rely on centralized exchanges to make sure their assets do not become compromised. More lenders participate when they can trust in a secure system, and, in turn, traders benefit from lower interest rates generated by a healthy amount of lenders. bZx supports 60+ ERC20 tokens, and as new margin calling solutions develop, that number will expand to encompass all of them. Instead of passively keeping tokens in an ETH wallet, users can leverage a secure way to lend out of their ERC20s and earn interest. In providing solutions for security and settlement time for margin lenders, bZx effectively creates an ecosystem where any user of the Ethereum ecosystem can benefit.

7. Decentralized Exchange (DEX)

In centralized exchanges, a central party holds the private keys to your wallet and ultimately has control of your funds. In a decentralized exchange, smart contracts replace the centralized third party, allowing you to keep control of your wallet and funds. When you use centralized exchanges, you are exposed to custodial risk. Custodial risk is the risk you take when you allow someone to have control of the private keys to your funds. Centralized exchanges have three main risks:
1) The exchange gets hacked.
2) The exchange runs away with your funds (an “exit scam”).
3) A regulatory crackdown causes your funds to be frozen or inaccessible.

Custodial risk is the risk of an exchange being hacked or otherwise losing lender funds. It has been estimated that centralized exchanges have lost over $800 million to hacks over the past two years. The unfortunate impact of these security issues is decreased liquidity in margin trading and prevention of efficient price discovery, thereby inhibiting correct asset pricing. This phenomena causes assets to fall victim to “bubble prices” and ultimately limits the number of users lending and trading on margin with crypto.

Decentralized exchanges (DEXes) present an obvious solution to security for crypto exchanges, as there is no vulnerable, centralized agent involved. However, while this minimizes the custodial risk that traders and margin lenders face, lenders still face the significant risk factor of counterparty risk.

Margin lenders face counterparty risk when borrowers are not consistently liquidated in time for the lender to regain their assets. When users do not feel safe about lending out their tokens, they end up participating less in margin lending. The fewer the lenders that use a platform, the higher interest rates become for margin traders. When interest rates become too high for traders, less will participate in margin trading and the overall health of the exchange will decrease. Fortunately, a solution has been devised and is readily available through the unique architecture and integration of the bZx protocol and its oracle layer. To understand exactly how this complex problem is tackled, let's take a deeper dive into the mechanics of the protocol.

Embodiments of the present disclosure mitigate custodial risk, as well as counter party risk, by providing a protocol and oracle layer that serves as a decentralized and trustless custodian in a margin lending and trading environment.

### III. Platform Operation

Embodiments of the present disclosure provide a hardware and software platform operative by a set of methods and computer-readable media comprising instructions configured to operate the aforementioned modules and computing elements in accordance with the methods. The following depicts an example of a method of a plurality of methods that may be performed by at least one of the aforementioned modules. Various hardware components may be used at the various stages of operations disclosed with reference to each module.

Furthermore, although the stages of the following example method are disclosed in a particular order, it should be understood that the order is disclosed for illustrative purposes only. Stages may be combined, separated, reordered, and various intermediary stages may exist. Accordingly, it should be understood that the various stages, in various embodiments, may be performed in arrangements that differ from the ones claimed below. Moreover, various stages may be added or removed from the without altering or deterring from the fundamental scope of the depicted methods and systems disclosed herein.

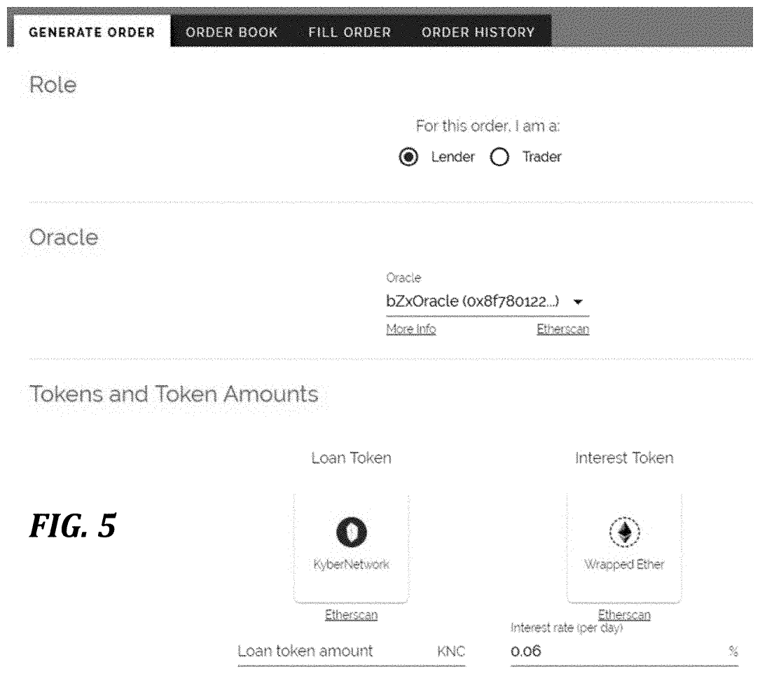

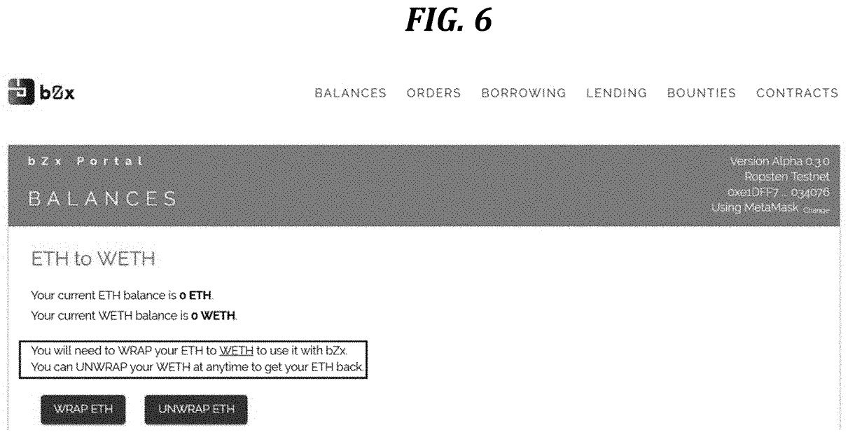

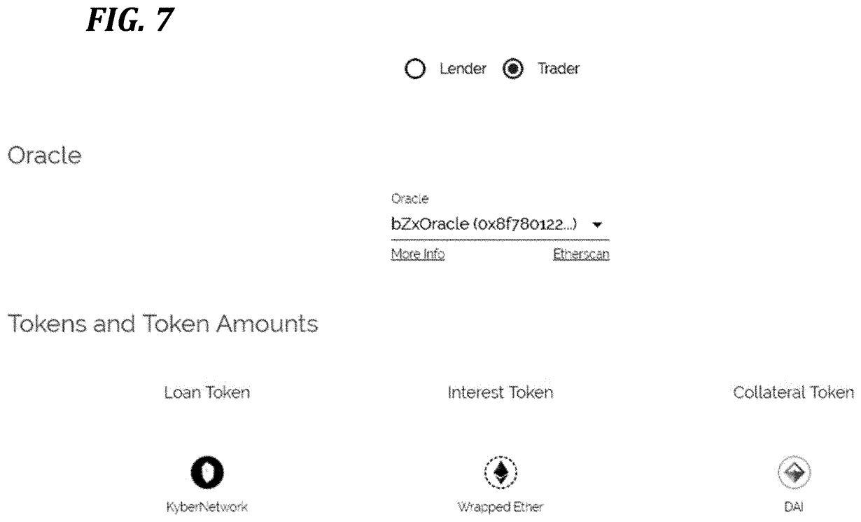

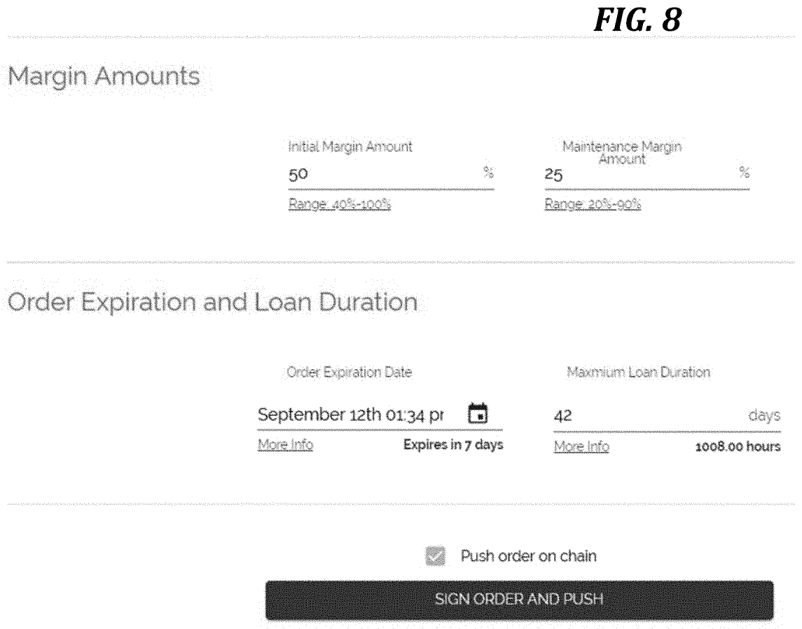

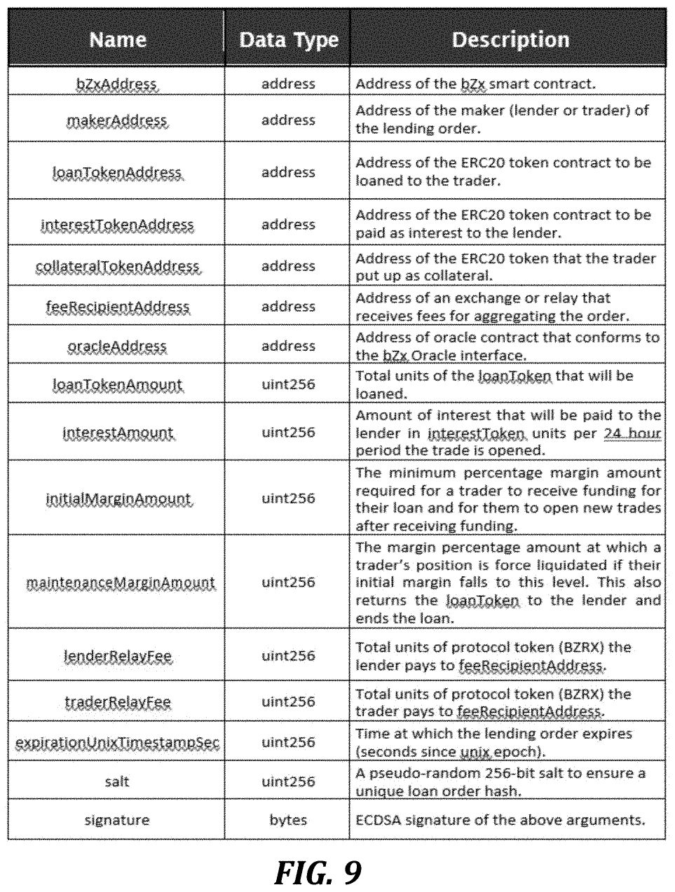

FIGS. 5-9 illustrate various interfaces associated with the below referenced stages. Consistent with embodiments of the present disclosure, a method may be performed by at least one of the aforementioned modules. The method may be embodied as, for example, but not limited to, computer instructions, which when executed, perform the method. The method may be comprise the following stages:

Stage 1: Order Generation

In a first stage, an Order Object (OO) may be created. A user of the platform, such as maker, may specify the parameters of the OO. Not all of the parameters may be specified. For example, the parameters specified by the maker in the OO may vary based on whether the maker is a borrower (also referred to herein as a “trader”) or a lender. The maker may create the OO through the user interface layer, which may vary for user type. The user interface may be provided by, for example, but not limited to, a relay.

Once the order object is created, in some embodiments, the OO may be broadcasted or otherwise shared, so as to be discoverable by a taker. Broadcasting may comprise, but not limited to, a publication of the OO on a medium. In some embodiments, the medium may be selected by the maker. The medium may comprise, but not be limited to, for example:
Text
E-mail
Social network
Website
Morse code, or
Forum.

Still consistent with embodiments of the present disclosure, the OO may be boarded by the Relay. Here, the OO may added as an order in the order book on the Relay. In some embodiments, the OO is published be the Relay on a medium of choice.

A taker (e.g., a Lender) may discover the OO on the medium, or be provided with the OO directly from a maker. The taker may accept the order associated with the OO and fill the order. Accordingly, the taker may complete the remaining parameters of the OO. In other instances, the taker must agree to certain parameters and, in some embodiments, may further modify the parameters specified by the maker. For example, an Oracle that is to govern the OO may be agreed upon and designated by the maker and taker. In turn, the agreed upon Oracle is then specified in the OO.

Then, a filled OO may be considered accepted. Upon acceptance, the OO may be communicated to and received by the protocol layer. For example, in some embodiments, bZx.sol may receive the OO from, for example, a relay or a taker via an API such as, for example, bZx.js. Once the filled OO is received by the protocol layer, a plurality of processes may be performed prior to deploying the order on-chain. The processes may include, but not be limited to, for example, a validation of the OO. The validation may verify that, for example, the OO has not been already accepted or already on-chain.

In some embodiments, a relay may serve as an open order book. Here, a taker may accept an order and place the order to a smart contract. In other embodiments, a relay may serve to place the order to a smart contract. For example, the relay may first prioritize price and time of order acceptance. Accordingly relays may implement methods and function calls to the smart contracts.

The protocol layer may then access funds, which may be represented as tokens on a blockchain, at an address associated with those tokens. Accordingly, bZx.sol may send the loan funds from lender, collateral from trader, and interest from trader to bZxVault.sol. Here, the funds will remain in escrow, thereby initiating the platform as a custodian of the funds.

Stage 2: Active Order Management

It should be understood that the protocol layer may be embodied as a smart contract or a series of smart contract. The smart contract(s) may, in turn, employ rules as specified in, at least in part, the order object and a selected oracle, for acting as a custodian of the funds. Accordingly, the platform may enable the management of trader activities, lender activities, and bounty hunter activities under the governance of the smart contract(s) employed by the OO. The following only discloses some of the available functions provided by the platform. It should be understood that all conventional margin lending and trading capabilities may be configured so as to be provided by the platform.

a. Trader Management

A trader UI, as provided by the UI layer may used by the trader to manage the loan once the funds are lent, including, but not limited to, for example, the opening of trades, the closing of trades, and ending a loan early. In some embodiments, the trader UI may be provided by a relay. It should be understood that the trading may be regulated by the protocol and oracle layers of the platform. This may include, but not be limited to, for example, the tracking of the location of tokens and addresses at which the tokens reside.

The trader UI may invoke a price feed method (PFM) to display retrieved and/or calculated values for the funds under management, as well as the values of other assets that the trader may desire to engage. It may then receive a trade request initiated by the trader and communicate the request to the protocol layer. For example, the trade request may be received by one or more smart contracts (e.g., bZx.sol) through the API layer.

In turn, the received request may then be sent to a designated oracle. The request may be transmitted through, for example, the Oracle_Interface.sol sub-module. The oracle may approve or decline the request based on certain verifications which may be based on, at least in part, the OO parameters.

When approved, a trade may be executed. Various embodiments may execute the trade in different ways. For example, bZx.sol may execute the trade via 0x protocol using bZxTo0x.sol. In other embodiments, the trade may be executed at the oracle layer. For example, the oracle layer may employ a DEX to execute the trade directly.

The trader UI may further enable the trader to terminate the loan early. Here, the trader may invoke, for example, a liquidation method at the protocol layer, through, for example, the API.

b. Lender Management

A lender UI, as provided by the UI layer may used by the lender to manage the loan once the funds are lent. In some embodiments, the lender UI may be provided by a relay. It should be understood that the lending may be regulated by the protocol and oracle layers of the platform. This may include, but not be limited to, for example, the tracking of the location of tokens and addresses at which the tokens reside.

The lender UI may invoke a price feed method (PFM) to display retrieved and/or calculated values for the funds under management, as well as the values of other assets that the lender may desire to engage. The lender UI may further enable a lender to invoke an interest payout for the loan.

Accordingly, the UI may cause an interest payout request to be sent to the protocol layer. For example, a relay may send an interest payout request to one or more smart contracts (e.g., bZx.sol) via the API layer. In turn, the received request may then be sent to a designated oracle. The request may be transmitted through, for example, the Oracle_Interface.sol sub-module. The oracle may approve or decline the request based on certain verifications which may be based on, at least in part, the OO parameters. When approved, the oracle may cause a payout of the accrued interest to lender.

c. Bounty Hunter Management

A bounty hunter UI, as provided by the UI layer may used by the bounty hunter to view active loans and determine which active loans to liquidate. In some embodiments, the bounty hunter UI may be provided by a relay. It should be understood that the bounty hunter actions may be regulated by the protocol and oracle layers of the platform.

Embodiments of the bounty hunter UI may enable the bounty hunter to request and/or view, for example, various OO parameters associated with active loans. For example, a relay may send a request received from the bounty hunter UI to one or more smart contracts (e.g., bZx.sol) via the API layer. The request may be approved or declined based on certain verifications which may be based on, at least in part, the OO parameters. When approved, the OO parameters may be relayed back to the bounty hunter UI.

Embodiments of the bounty hunter UI may enable the bounty hunter to invoke the liquidation of one or more active loans. For example, a relay may send a request received from the bounty hunter UI to one or more smart contracts (e.g., bZx.sol) via the API layer. In turn, the received request may then be sent to a designated oracle. The request may be transmitted through, for example, the Oracle_Interface.sol sub-module. The oracle may approve or decline the request based on certain verifications which may be based on, at least in part, the OO parameters. Furthermore, a check on the prices of the traded assets may be performed to ensure the proper liquidation threshold is met. When approved, the oracle may cause an execution of the liquidation method at the protocol layer.

Stage 3: The Liquidation Method

Consistent with embodiments of the present disclosure, a liquidation method may be invoked. Although a bounty hunter is disclosed to invoke a liquidation method in certain scenarios, it is anticipated that liquidation may be invoked by one or more automated means including, for example, but not limited to, smart contracts, bots, or other automated configurations.

Once received, a liquidation request may be transmitted to an oracle. For example, one or more smart contracts (e.g., bZx.sol) may receive a liquidation request from the Relay via API and then forward liquidation request to the oracle. In other embodiments, the smart contract may itself originate the liquidation request.

The oracle may check the validity of the request. For example, the oracle may retrieve values associated with the assets in question from at least one DEX (three or more preferred). Outlier(s) is/are removed when a plurality of DEXs are used. Then, in some embodiments, a Volume Weighted Average (VWA) is used to establish price value for the assets from remaining DEXs. The VWA may compared with the parameters in OO.

If all parameters for liquidation are met, the liquidation method may be executed by the Oracle. Execution may comprise, but not be limited to, the execution of on-chain trades to close all positions associated with the lent assets. Closing the positions may comprise, for example, the conversion of any assets back to the original lent and collateralized assets.

Upon liquidation, the funds associated therewith may be distributed. For example, the principal and interest returned to the lender. In some embodiments, interest may be based on time, with unused pre-allocated interest to be returned to the trader. Furthermore, in some embodiments, a portion of the interest (e.g., 10%) may be allocated to a decentralized insurance fund (DIF).

Still consistent with embodiments of the disclosure, the invocation of a liquidation method may require a payment of a fee. For example, as is well known in the field of the present disclosure, smart contract execution on a blockchain protocol may require a payment to a node, or miner, executing the smart contract operation. In this instance, the calculate fee, or “gas” may be paid to the miner. As the party responsible for invoking the liquidation method of the smart contract may be required to pay the gas (e.g., the bounty hunter), the gas should be refunded back to the party. As such, the fee may be paid from a collateral associated with the lent asset. Further still, in various embodiments, an oracle may also receive a fee for governing the loan. In turn, any remaining funds, if any, may be paid to the trader.

Stage 4: Incentive Calculation and Distribution

Protocols consistent with embodiments of the present disclosure may employ varying incentive calculation and distributions methods. The following is provided to serve as an example of some incentive calculation and distributions methods that may serve the purpose of incentivizing the operation of a decentralized margin lending and trading protocol to the benefit of the various technical advantages associated therewith.

a. Relay Incentive

A relay may collect a fee from its participation in the protocol by charging relay fees. For example, in some embodiments, the relay may set its own fees for the usage of its interfaces for the acting parties. The fees may be paid out in Protocol Tokens (e.g., a BZRX token).

b. Bounty Hunter Incentive

A bounty hunter may collect a fee from the successful execution of a liquidation method. The fees to the bounty hunter may be paid out in, for example, but not limited to, an ERC20 token specified by the Oracle used in the management of the liquidated loan. In some embodiments, the fees may be proportional to the gas used to execute liquidation.

c. Oracle Incentive

An oracle may collect a fee from its participation in the protocol by charging oracle fees. For example, in some embodiments, the oracle may set its own fees for the usage of its one or more smart contracts. The fees to the oracle may be paid out in, for example, but not limited to, an ERC20 token that was lent. The fee may be paid upon liquidation.

d. Lender Incentive

A lender may collect a fee from its participation in the protocol by charging interest fees. For example, in some embodiments, the lender may set its own fees through the order object parameters. The fees may be, for example, an accrued interest on the assets lent. In some embodiments, the interest may be accrued daily. The fees to the lender may be paid out in, for example, but not limited to, an ERC20 token that was lent. The fee may be paid upon liquidation, or upon request by the lender.

e. Trader Incentive

A trader may collect a profit from its participation in the protocol by successful trading the lent assets. For example, in some embodiments, the protocol layer may serve as a custodian of the lent assets and enable the trader to trade on a margin, or short the assets lent. The earning may be collected by the trader upon liquidation, or on an ongoing basis.

sigAlthough the stages are disclosed in a particular order, it should be understood that the order is disclosed for illustrative purposes only. Stages may be combined, separated, reordered, and various intermediary stages may exist. Accordingly, it should be understood that the various stages, in various embodiments, may be performed in arrangements that differ from the ones claimed below. Moreover, various stages may be added or removed from the without altering or deterring from the fundamental scope of the depicted methods and systems disclosed herein. Embodiments of the present disclosure provide a hardware and software platform operative as a distributed system of modules and computing elements.

### IV. Aspects

The following disclose various Aspects of the present disclosure. The various Aspects are not to be construed as patent claims unless the language of the Aspect appears as a patent claim. The Aspects describe various non-limiting embodiments of the present disclosure.

1. User Interface Layer
a. Maker
b. Taker
c. Bounty Hunter (BH)
d. Features
   i. Margin Trading
   ii. Margin Lending
   iii. Decentralized Exchanges (DEX)
   iv. Custodial Risk

2. Order Object (OO)
a. bZxAddress
b. makerAddress
c. loanTokenAddress
d. interestTokenAddress
e. collateralTokenAddress
f. feeRecipientAddress
g. oracleAddress
h. loanTokenAmount
i. interestAmount
j. initialMarginAmount
k. maintenanceMarginAmount
l. lenderRelayFee
m. traderRelayFee
n. expirationUnixTimestampSec
o. Salt
p. Signature
q. Loan Token
r. Loan Duration
s. Oracle Hash
t. Interest Token

3. Relays

4. API
a. bZx.js library

5. Protocol Layer
a. BZRX Token
b. bZx.sol
   i. takeLoanOrderAsTrader
   ii. takeLoanOrderAsLender
   iii. pushLoanOrderOnChain
   iv. takeLoanOrderOnChainAsTrader
   v. takeLoanOrderOnChainAsLender
   vi. preSign
   vii. preSignWithHash
   viii. cancelLoanOrder
   ix. cancelLoanOrderWithHash
   x. getLoanOrderHash
   xi. isValidSignature
   xii. getInitialCollateralRequired
   xiii. getSingleOrder
   xiv. getOrdersFillable
   xv. getOrdersForUser
   xvi. getSingleLoan
   xvii. getLoansForLender
   xviii. getLoansForTrader
   xix. getActiveLoans
   xx. getLoanOrder
   xxi. getLoanOrderAux
   xxii. getLoanPosition
   xxiii. tradePositionWithx
   xxiv. tradePositionWithxV
   xxv. tradePositionWithOracle
   xxvi. depositCollateral
   xxvii. withdrawCollateral
   xxviii. changeCollateral
   xxix. withdrawPosition
   xxx. depositPosition
   xxxi. changeTraderOwnership
   xxxii. changeLenderOwnership
   xxxiii. increaseLoanableAmount
   xxxiv. setLoanOrderDesc
   xxxv. getPositionOffset
   xxxvi. paylnterest
c. bZxVault.sol
d. bZxTox.sol
e. Oracle_Interface.sol

6. Oracle Layer
a. bZxOracle
b. KyberNetwork

7. Decentralized Exchange (DEX)

Stage 1: Order Generation
a. Order Object (OO) Object Creation
   OO gets created and parameters partially populated by the Maker
      OO may be created on a Relay through a Relay UI
b. OO Broadcasting
   OO is broadcasted/published on a medium of choice by Maker and/or Relay. Chosen medium can include, but not limited to:
      Text
      E-mail
      Social network
      Website
      Morse code
      Newspaper
      Etc.
   Relay Broadcasting Embodiments
OO is submitted to the Relay by the maker
OO is added as an order in the order book on the Relay
OO is published be the Relay on a medium of choice

c. OO Accepting
OO is received by the Taker from the Publication Medium
Order gets filled by the Taker, and remaining parameters of the OO get populated
An Oracle is agreed upon and designated by the Maker and Taker
The agreed upon Oracle is then specified in the OO

d. OO On-Chain Activation
bZx.sol (Protocol) receives OO from the Relay/Taker via bZx.js (API)
bZx.sol sends loan funds from lender, collateral from trader, and interest from trader to bZxVault.sol (Escrow)

Stage 2: Active Order Management
a. Price Feed Method (PFM)
   Price feed request is initiated by the user on the Relay using the UI
   bZx.sol receives the price feed request from the Relay via API
   bZx.sol sends request to Oracle via Oracle_Interface.sol
   Price feed is received by bZx.sol from the Oracle
   bZx.sol forwards the price feed to the Relay
   Price feed is presented to the user using the UI by the Relay
b. Trader Management Activities—User Interface (UI) is used by the Trader to manage the loan once the funds are lent, including the opening of trades, the closing of trades, and ending a loan early.
   Price feed
      PFM is invoked by the Trader
   Trade opening and closing
      Trade request is initiated by the trader on the Relay using the UI
      bZx.sol receives the trade request from the Relay via API
      bZx.sol sends request to oracle for approval via Oracle_Interface.sol
      Trade is either approved or denied by the Oracle, based on the OO parameters
      If approved, trade is executed one of following ways
         bZx.sol executes trade via 0x protocol using bZxTo0x.sol
         Trade is executed by the Oracle using other means such as KyberNetwork
   Early termination of the loan
      Liquidation Method is invoked by the trader
c. Lender Management
   Price Feed
      PFM is invoked by the lender
   Interest payout
      Relay sends interest payout request to bZx.sol via API
      bZx.sol forwards request to Oracle via Oracle_Interface.sol
      Oracle verifies the request is valid
      Oracle pays out the accrued interest to lender
d. Bounty Hunter Management
   Active Loans
   Price Feed
      PFM is invoked by the BH
   OO parameters
      OO parameters are requested by BH from the Relay
      bZx.sol receives OO parameters request from the Relay using API
      bZx.sol sends OO parameters to the Relay using API
      Relay presents OO parameters to the BH using UI
   Prices from price feed are compared with OO parameter values by BH
   If Liquidation quota is met, liquidation method is invoked by BH

Stage 3: Liquidation Method
a. Liquidation request is invoked by the user on the Relay using the UI
b. bZx.sol receives liquidation request from the Relay via API
c. bZx.sol forwards liquidation request to the Oracle
d. Request Validity is checked by the Oracle
   Price is retrieved from at least one DEX (three or more preferred)
   Outlier(s) is/are removed when a plurality of DEXs are used
   Volume Weighted Average (VWA) is used to establish price value from remaining DEXs
   VWA is compared with the parameters in OO
e. Liquidation Execution
   If all parameters for liquidation are met, liquidation is executed by the Oracle
      On-chain trades are made to close all positions (If needed)
      Funds distribution
         Principal returned to the lender
         Interest Distribution (Based on time. Unused interest returned to trader)
         90% of interest is paid to the lender
         10% of interest is paid to the Decentralized Insurance Fund (DIF)
         Refunds for GAS paid from collateral
         If BH executed liquidation, BH is paid from collateral proportionally to the gas used to execute liquidation
         Oracle fee paid from collateral
         Remaining funds/collateral (if any) paid to the trader

Stage 4: Incentive Calculation and Distribution
a. Relay Incentive
   Paid out in BZRX token only
   Profit made by charging fees
b. BH Incentive
   Paid out in ERC20 token specified by the Oracle used
   Profit made if BH successfully executes a liquidation
   Profit is directly proportional to the gas used to execute liquidation
c. Oracle Incentive
   Paid out in ERC20 token that was lent
   Charges a fee that is paid from the collateral upon liquidation
d. Lender Incentive
   Paid out in ERC20 token specified in OO
   Profit made on accrued interest
   90% of the interest accrued daily is received as profit by the lender
e. Trader Incentive
   Paid out in ERC20 token specified in OO
   Profits made from margin trading
   Profits made from shorting

Stage 5: Oracles (Governance and Marketplace)
a. Creation/Registration
   Can be created by anyone at anytime
   Must be registered in the bZx Oracle Registry
   Must have source code published
   Must be publicly vetted and accepted through decentralized governance
b. Marketplace
   Basis formed by competing Oracles
   Contains all registered and publicly accepted Oracles
   Contains public rating for each Oracle
   Lender/Trader can pick Oracle commissioned by self
c. Responsibilities
   Oversee positions taken
      Keep track of trades
      Accept/Reject trades
   Manage price feed
   Control liquidation logic
d. Governance
   Fees chosen by Oracle contract
      0 fee is allowed
      Oracle fee chosen
      BH fee chosen
      Taker fee chosen
   Reliability depends on Oracle contract logic
   Can be partially centralized
   Can be fully or partially on-chain
   Can impose constraints on liquidation method
   Can choose the payout token used for
      Gas reimbursements
      BH payouts
      Taker fees
   Can choose source(s) of price feed
   Can choose prices to consider for liquidation logic
   Can limit who can become BH
      Trader/Lender can be own BH
   Can control and make all trades
   Can control Gas price calculation logic
   Can control DIF
      No funds allocated for DIF allowed
      Amount of funds allocated for DIF
      Source of funds for DIF
   Can decide what loan parameters are insurable

An order object consistent with embodiments of the present disclosure may comprise at least one of, but not limited to, the following parameters:
bZxAddress
   Type—Address
   Description: Address of the bZx smart contract.
makerAddress
   Type—Address
   Description—Address of the maker (lender or trader) of the lending order.
loanTokenAddress
   Type—Address
   Description—Address of the ERC20 token contract to be loaned to the trader.
interestTokenAddress
   Type—Address
   Description—Address of the ERC20 token contract to be paid as interest to the lender.
collateralTokenAddress
   Type—Address
   Description—Address of the ERC20 token that the trader put up as collateral.
feeRecipientAddress
   Type—Address
   Description—Address of an exchange or relay that receives fees for aggregating the order.
oracleAddress
   Type—Address
   Description—Address of the oracle contract that conforms to the bXz Oracle interface.
loanTokenAmount
   Type—Unit256
   Description—Total units of the loan Token that will be loaned.
interestAmount
   Type—Unit256
   Description—Amount of interest that will be paid to the lender in interestToken units per 24 hour period the trade is opened.
initialMarginAmount
   Type—Unit256
   Description—The minimum percentage margin amount required for a trader to receive funding for their loan and for them to open new trades after receiving funding.
maintenanceMarginAmount
   Type—Unit256
   Description—The margin percentage amount at which a trader's position is force liquidated if their initial margin falls to this level. This also returns the loanToken to the lender and ends the loan.
lenderRelayFee
   Type—Unit256
   Description—Total units of protocol token (BZRX) the lender pays to feeRecipientAddress.
traderRelayFee
   Type—Unit256
   Description—Total units of protocol token (BZRX) the trader pays to feeRecipientAddress.
expirationUnixTimestampSec
   Type—Unit256
   Description—Time at which the lending order expires (seconds since unix epoch).
Salt
   Type—Unit256
   Description—A pseudo-random 256-bit salt to ensure a unique loan order hash.
Signature
   Type—Bytes
   Description—ECDSA signature of the above arguments.
Loan Token
   Description—The loan token may define the type of asset being lent.
Loan Duration
   Description—The loan duration may define a length of the loan.
Oracle Hash
   Description—The oracle may define a property of the oracle to govern the loan.
Interest Token
   Description—The interest token may define the type of token for interest fees.

A smart contract consistent with embodiments of the present disclosure may be operative to execute at least one function disclosed with reference to the protocol and oracle layers. For example, a smart contract may comprise, but not be limited to the following methods:

Lender—A person/entity wishing to lend tokens, such as ERC20 tokens or assets wrapped in ERC20 token.

Borrower—A person/entity wishing to trade on margin or short an ERC20 token or assets wrapped in ERC20 token.

Bounty Hunter—A bounty hunter is a third party (person/entity/automation) that watches all open positions. The bounty hunter may trigger a liquidation contract positions if they are below their margin maintenance, as defined in the loan agreement. By doing this, the bounty hunter ensures that lenders are kept whole.

Oracle Owner—A person/entity who creates and maintains a smart contract acting as an Oracle.

Maker—A person or entity that creates an order to be filled. A maker may either be lender or borrower.

Taker—A person or entity that accepts and signs the order. This can be either lender or borrower.

Margin Trading—Margin trading has two main aspects: trading with leverage and shorting. In trading with leverage, a trader borrows assets to increase the amount of assets they are trading. By doing so, they magnify the gains or losses of their trade. The borrowed assets are known as a margin loan. To obtain the margin loan, the trader puts up assets that serve as collateral. The terms of the margin loan specify a collateral-to-loan ratio. If the trade falls below the specified ratio, the trade is liquidated, and the lender is made whole using the trader's collateral. Margin trading also includes shorting. In shorting, a trader essentially sells assets they do not own. The short investor borrows an asset and sells it on the expectation that the assets will lose value.

Margin Lending—In margin lending, a lender lends funds to a margin trader who trades with those funds. The lender receives interest on the funds loaned out.

### V. Claims

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

1. A system comprising:
a user interface (UI) layer,
wherein the ui layer provides an interface for at least one of the following:
a maker, wherein the maker is enabled open an order with a creation of an order object,
a taker, wherein the taker is enabled to accept the order and complete the order object, and
a bounty hunter, wherein the bounty hunter is enabled to access the order object and trigger a liquidation of the order,
a relay layer,
wherein the relay layer is configured to perform at least one of the following:
broadcast the order object,
receive an acceptance and completion of the order object, and
relay the order object to a protocol layer, and
a protocol layer,
wherein the protocol layer comprises at least one of the following:
an entry smart contract for receiving the accepted and completed order object,
an escrow smart contract for holding funds associated with the order object,
an oracle interface smart contract for interfacing with at least one oracle smart contract.

2. The system of claim 1, wherein the order object represents a margin loan.

3. The system of claim 2, wherein the protocol layer is configured to perform at least one of the following:
monitor activity associated with the margin loan,
request validation, from the oracle smart contract, for the activity associated with the margin loan,
receive validation, from the oracle smart contract, for the activity associated with the margin loan, and
permit, upon receipt of validation, the activity by at least one of the following:
a trader,
a lender, and
the bounty hunter.

4. The system of claim 2, wherein the order object specifies the oracle smart contract to be used for governing the margin loan.

5. The system of claim 4, further comprising an oracle market place for selecting the oracle smart contract.

6. The system of claim 5, wherein the maker and the taker mutually agree upon the oracle smart contract.

7. The system of claim 2, wherein the protocol layer is configured to perform, based at least in part on parameters of the order object, at least one of the following:
escrow funds associated with the margin loan,
track all trades associated with the margin loan,
close all positions associated with the margin loan, and
distribute the funds associated with the margin loan.

8. The system of claim 7, wherein the distribution of funds by the protocol layer is comprises at least one incentive for at least one of the following:
the lender,
the trader,
the bounty hunter,
the relay, and
the oracle smart contract.

9. The system of claim 1, further comprising an API layer, wherein the API layer is configured to enable a communication between the relay layer and the protocol layer.

10. The system of claim 1, wherein the UI layer and the Relay Layer are off-chain, and wherein the protocol layer and the oracle layer are, at least in part, on-chain.

11. A method comprising:
generating an order object for a margin loan,
wherein the order object comprises a plurality of parameters for specifying aspects of the margin loan and an oracle smart contract for governing the margin loan;
broadcasting the order object for the margin loan,
wherein broadcasting the order object comprises displaying at least one of the plurality of parameters for specifying the margin loan;
receiving an acceptance of the margin loan represented by the order object,
wherein receiving the acceptance of the margin loan comprises completing at least one additional parameter of the order object;
escrowing funds associated with the margin loan,
wherein the funds are escrowed by an escrow smart contract;
receiving a request for trading the funds on a decentralized exchange,
wherein the request is forwarded to the oracle smart contract for governing the margin loan;
receiving approval for the trade of funds,
wherein the approval is received from the oracle smart contract; and
enabling the trading the funds on the decentralized exchange,
wherein the trading of funds on the decentralized exchange is enabled by at least one of the following: an exchange interfacing smart contract and an oracle interfacing smart contract.

12. The method of claim 11, further comprising:
receiving a request to liquidate the margin loan;
forwarding the request to the oracle smart contract; and
receiving an approval to liquidate the margin loan from the oracle smart contract.

13. The method of claim 12, further comprising liquidating the margin loan, wherein liquidating the margin loan comprises:
closing all positions associated with the margin loan, and
distributing the funds associated with the margin loan.

14. The method of claim 13, wherein distributing funds comprises providing at least one incentive for at least one of the following:
the lender,
the trader,
the bounty hunter,
the relay, and
the oracle smart contract.

15. The method of claim 12, wherein receiving the request to liquidate the margin loan comprises receiving a request invoked by a bounty hunter.

16. The method of claim 12, further comprising:
retrieving at least one price associated with assets associated with the margin loan.

17. The method of claim 16, wherein retrieving the at least one price comprises:
retrieving the prices from a plurality of decentralized exchanges,
removing outliers values from the retrieved prices,
taking the volume waited average (VMA) of the retrieved prices without the outliers, and
compare the VMA with at least one parameter in the order object.

18. The method of claim 18, further comprising granting approval for the liquidation of the margin loan.

19. The method of claim 18, wherein granting the approval for the liquidation of the margin loan comprises granting the approval based on the comparison of the VMA to the at least one parameter of the order object.

20. The method of claim 15, further comprising calculating a reward for the bounty hunter,
wherein the reward is based, at least in part, on a fee paid by the bounty hunter to invoke the liquidation of the margin loan.
